(19) United States
(12) Patent Application Publication
(10) Pub. No.: US 2015/0256265 A1
(43) Pub. Date: Sep. 10, 2015

(54) System and Method for Chromatic Dispersion Tolerant Direct Optical Detection

(71) Applicant: FUTUREWEI TECHNOLOGIES, INC., Plano, TX (US)

(72) Inventors: Chen Chen, Ottawa (CA); Chuandong Li, Ottawa (CA); Zhuhong Zhang, Ottawa (CA)

(73) Assignee: FUTUREWEI TECHNOLOGIES, INC., Plano, TX (US)

(21) Appl. No.: 14/201,583

(22) Filed: Mar. 7, 2014

(51) Int. Cl. H04B 10/58; H04B 10/50; H04B 10/564

(52) U.S. Cl. CPC H04B 10/58; H04B 10/564; H04B 10/503

(57) ABSTRACT

Embodiments are provided to improve direct detection for optical transmissions. In an embodiment, a method by a transmitter for a direct detection system includes driving, via a drive voltage, a single-side band (SSB) signal at an optical modulator on a first optical path of the transmitter. The SSB signal is sufficiently linear with respect to the drive voltage for allowing direct detection at a receiver. The method further includes generating a DC carrier signal on a second path of the transmitter. The SSB signal is combined with the DC carrier signal at an output of the transmitter.

### TECHNICAL FIELD

The present invention relates to the field of optical communications, and, in particular embodiments, to a system and method for chromatic dispersion tolerant direct optical detection.

### BACKGROUND

Chromatic dispersion (CD) can result in frequency-dependent fading for double-side band (DSB) optical signal transmission when a direct detection receiver type is used. This fading effect can be circumvented by transmitting a single-side band (SSB) signal generated via digital signal processing (DSP). The SSB causes orthogonal frequency-division multiplexing (OFDM) subcarriers after direct detection to experience a frequency-dependent phase shift without CD. The frequency-dependent phase shift can then be compensated using a one-tap linear equalizer. To facilitate direct detection, the optical carrier is transmitted along with the SSB signal over the optical fiber. One method to generate this optical carrier is to use a DC bias voltage at the optical modulator at the transmitter. However, the presence of the DC bias causes the optical modulator to operate in a nonlinear region of its transfer function. This produces a non-ideal SSB signal and its transmission becomes no longer immune to the CD induced fading effect. Hence, the detection performance is severely degraded. There is a need for an improved transmission scheme that allows efficient CD tolerant direct optical detection.

### SUMMARY OF THE INVENTION

In accordance with an embodiment of the disclosure, a method by a transmitter for a direct detection system includes driving, via a drive voltage, a single-side band (SSB) signal at an optical modulator on a first optical path of the transmitter. The SSB signal is sufficiently linear with respect to the drive voltage for allowing direct detection at a receiver. The method further includes generating a DC carrier signal on a second path of the transmitter. The SSB signal is combined with the DC carrier signal at an output of the transmitter.

In accordance with another embodiment of the disclosure, a method by a transmitter for a direct detection system includes generating, using digital signal processing (DSP), a digital signal for optical communications, and generating, according to the optical signal, a drive voltage for an optical modulator. The method further includes splitting a laser output into a first path coupled to an optical modulator, and a second path separate from the optical modulator, and driving, using the drive voltage, a SSB signal at the optical modulator and the first path. The SSB signal is sufficiently linear with respect to the drive voltage for allowing direct detection at a receiver. Further, a DC carrier signal is generated at the second path. The SSB signal is combined with the DC carrier signal into an output signal of the transmitter.

In accordance with yet another embodiment of the disclosure, a transmitter for a direct detection system comprises a laser source, a first path and a second path both coupled to the laser source, an optical modulator coupled to the first path, at least one processor coupled to the optical modulator, and a non-transitory computer readable storage medium storing programming for execution by the at least one processor. The programming includes instructions to generate, using DSP, a digital signal for optical communications, and generate, according to the optical signal, a drive voltage for the optical modulator. The programming includes further instructions to drive, using the drive voltage, a SSB signal at the optical modulator. The SSB signal is sufficiently linear with respect to the drive voltage for allowing direct detection at a receiver. The transmitter is further configured to generate a DC carrier signal on the second path, and combine the SSB signal with the DC carrier signal into an output signal of the transmitter.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an optical transmission system that enables direct detection;

FIG. 2 illustrates a transmitter DSP for a direct detection optical transmission system;

FIG. 3 illustrates optical output amplitude versus (vs.) electrical drive voltage at different DS bias for a direct detection optical transmission system;

FIG. 4 illustrates an embodiment of an improved transmitter design with electro-optics for a direct detection optical transmission system;

FIG. 5 illustrates another embodiment of a method for transmission allowing CD tolerant direct optical detection; and

FIG. 6 illustrates a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

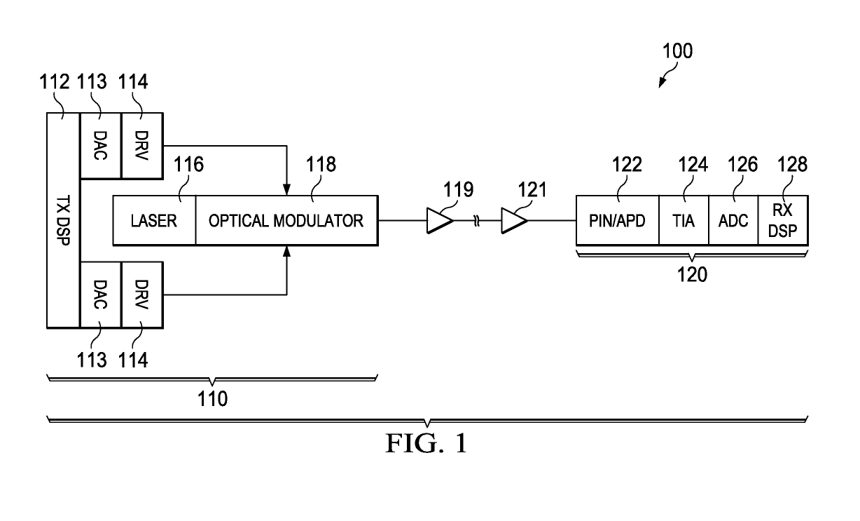

FIG. 1 shows an example of an optical orthogonal frequency-division multiplexing (OFDM) transmission system 100 that enables direct detection. The system 200 includes a transmitter 110 and a direct detection receiver 120, which are linked via an optical fiber. The transmitter 110 comprises a laser 116, an optical modulator 118 coupled to the output of the laser 116 to modulate the optical signals from the laser 116, and an optical amplifier 119 in front of the optical modulator 118. The optical modulator 118 is based on a Mach-Zehnder (MZ) interferometer design driven electrically by two arms. Each arm is coupled to a DSP unit 112 via a digital-to-analog converter (DAC) 113 and a radio frequency (RF) driver (DRV) 114. The direct detection receiver 120 includes a receiving optical amplifier 121 facing the transmitter 110, a PIN or avalanche photodiode (APD) 122 behind the receiving optical amplifier 121, an analog-to-digital converter (ADC) 126, a transimpedance amplifier (TIA) 124 between the PIN/APD 122 and the ADC 126, and a receiving DSP unit 128 coupled to the ADC 126.

Typically, OFDM transmissions with double-side band (DSB) from the transmitter 110 to the receiver 120 experience chromatic dispersion as they propagate via a fiber. This results in frequency-dependent fading and affects detection performance (increases signal errors). To overcome the fading effect due to CD, single-side band (SSB) signals are instead transmitted. As such, at the receiving DSP unit 128, OFDM subcarriers may only experience a frequency-dependent phase shift instead of the frequency-dependent fading. The frequency-dependent phase shift can then be compensated at the receiving DSP unit 128, for example, using a simple one-tap equalizer for instance.

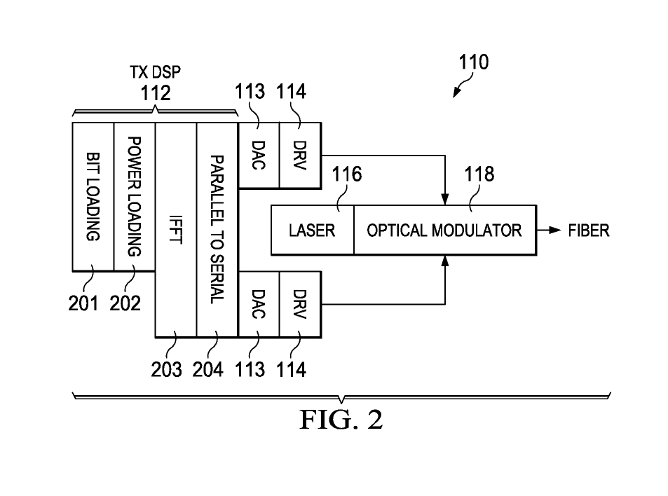

FIG. 2 shows the transmitter 110 including the DSP unit 112 with more details. The DSP unit 112 includes functional blocks for bit loading 201, power loading 202, inverse fast Fourier transform (IFFT) 203 or the like, and parallel to serial conversion 204. The bit and power loading are obtained using a water-filling algorithm, which optimizes the OFDM system performance. The DSP unit 112 generates the SSB signal, after the IFFT 203. The modulation is applied to either the positive or negative frequency subcarriers only, while the remaining subcarriers are zero-padded. The real and imaginary parts of the SSB signal are used to drive the two independent arms of the optical modulator 118 to realize electro-optical conversion. Examples of suitable optical modulators that can be used to generate the SSB signal include the dual-parallel MZ (DPMZ) and dual-drive MZ (DDMZ).

To facilitate direct detection, an optical carrier frequency is transmitted along with the SSB signal over the optical fiber, and is not suppressed as in other coherent optical transmission systems. This optical carrier can be generated by applying DC bias to the optical modulator 118 away from the null point. However, this DC bias scheme would force the optical modulator 118 to operate in the nonlinear region of its transfer function. As such, the resultant optical SSB signal becomes non-ideal and its transmission is no longer immune to the CD induced fading effect, which can severely degrade detection.

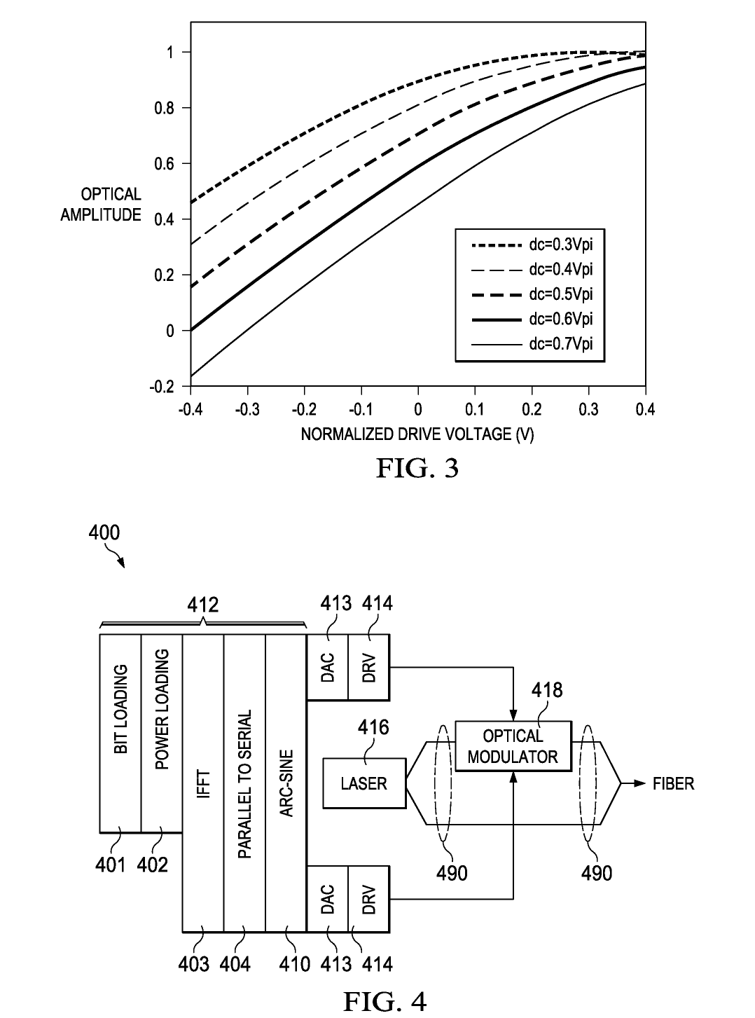

FIG. 3 is a graph showing an exemplary behavior of optical output amplitude vs. electrical drive voltage, which represents the modulator transfer function, at different DC bias values for the transmitter 110. The plotted data in the chart shows a simulation result. Specifically, the plot shows the modulation transfer function. The actual experimental transfer function can generally be well represented by this analytical (or simulation) result. The optical output is normalized against the maximum transmission amplitude. The electrical drive voltage is normalized against the modulator DC bias (Vpi) and is centered around zero voltage. It can be seen that modulator transfer function is not linear with respective to drive signal, which would cause distortion to the signal.

Embodiments are provided herein to resolve this issue and improve direct detection. The embodiments include using a modified transmitter electro-optics (EO) architecture to avoid performance degradation in direct detection. The architecture comprises splitting the laser output in to two paths. A first path is used for modulating the SSB signal using an optical modulator without introducing DC bias, which reduces or eliminates the nonlinear behavior of the modulator transfer function, and thus eliminates the fading effect. A second path is used to provide the carrier frequency (DC carrier). The two paths combine at the output to send a single-side band (SSB) signal combined with the DC carrier. Using this architecture and operation scheme also avoids signal to noise ratio (SNR)/bit error ratio (BER) frequency-dependent fading and improves transmission performance. This architecture and scheme can be used to improve transmission capacity and/or error performance in the presence of residue and/or uncompensated CD from optical fiber transmission. Although the embodiments are described in context of OFDM signals, the embodiments herein can be applied and extended to other optical signals which can be digitally generated.

FIG. 4 shows an embodiment of an improved transmitter 400 with a modified EO architecture for a direct detection system. For instance, the transmitter 400 can replace the transmitter 110 in the system 100 to improve system detection. The transmitter 400 comprises a DSP unit 412, a laser 416, an optical modulator 418 coupled to the laser 416 with two driving arms each coupled to the DSP unit 412 via a corresponding DAC 413 and a DRV 414. The DSP unit 412 includes functional blocks for bit loading 401, power loading 402, IFFT 403 or the like, and parallel to serial conversion 404. The components above of the transmitter 400 operate similar to the respective components of the transmitter 110.

The transmitter 400 or DSP unit 412 further includes an arc-sin function 410. The arc-sine function 410 is preconfigured and coupled or added to the DSP unit to further improve modulator linearity. The arc-sine function 410 can be used in the transmitter 400 so that the nonlinear mapping is kept ideal or acceptable at the optical modulator 418. Alternatively, the EO architecture of the transmitter 400 can be effective even without using the arc-sin function.

The output of the laser 416 is split into two optical paths, for instance into two optical fibers or any other suitable optical waveguides. Additionally, two optical couplers 490 can be added between the output of the laser 416 and the two paths to control the signal splitting ratio between the two paths to reflect the desired carrier to signal ratio. The splitting is realized by a first coupler 490 at the output of the laser, and the two optical paths are then recombined by a second coupler 490 at the input to the fiber. One path is modulated by the optical modulator 418 to produce a SSB signal, e.g., as described above. The other path is DC biased and serves as the DC carrier after both paths recombine (at the output of the transmitter 400). This EO architecture enables the optical modulator 418 to be biased at null point, so the modulator linearity region can be extended. In this case, NLE and linear equalizer components are not needed, which simplifies the DSP design. For example, a conventional transmitter DSP design similar to the DSP unit 112 can be used.

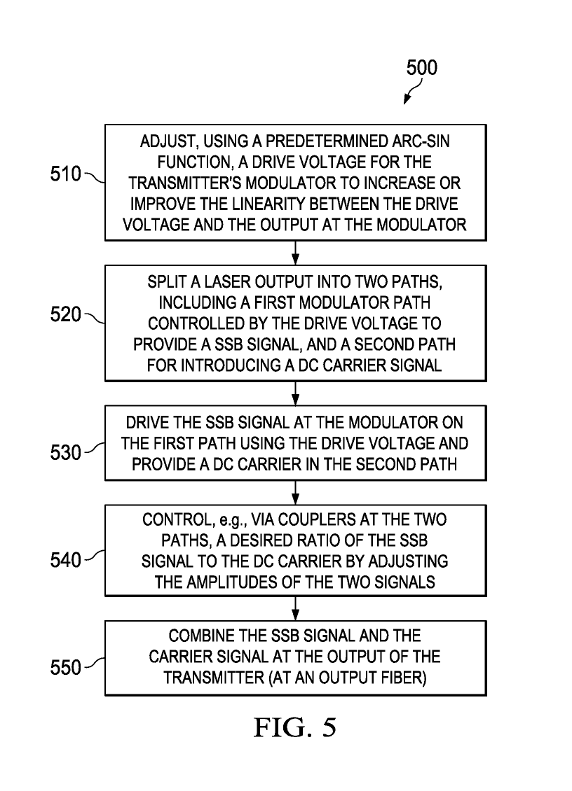

FIG. 5 shows an embodiment of another method 500 for transmission allowing chromatic dispersion tolerant direct optical detection. The method 500 can be implemented using the transmitter 400 with the modified EO architecture. At step 510, an arc-sin function (e.g., as part of DSP) adjusts the drive voltage to increase or improve the linearity between the drive voltage and the output at the modulator (the modulator transfer function linearity). At step 520, a laser output is split into two paths, including a first modulator path controlled by the drive voltage to provide a SSB signal, and a second path for introducing a DC carrier signal. At step 530, the SSB signal at the modulator on the first path is driven using the drive voltage, and the DC carrier is provided in the second path. At step 540, a desired ratio between the SSB and carrier signals is controlled by adjusting the amplitudes of the two signals. The ratio can be controlled via couplers at the two paths. At step 550, the SSB signal and the carrier signal are combined at the output of the transmitter (at an output fiber).

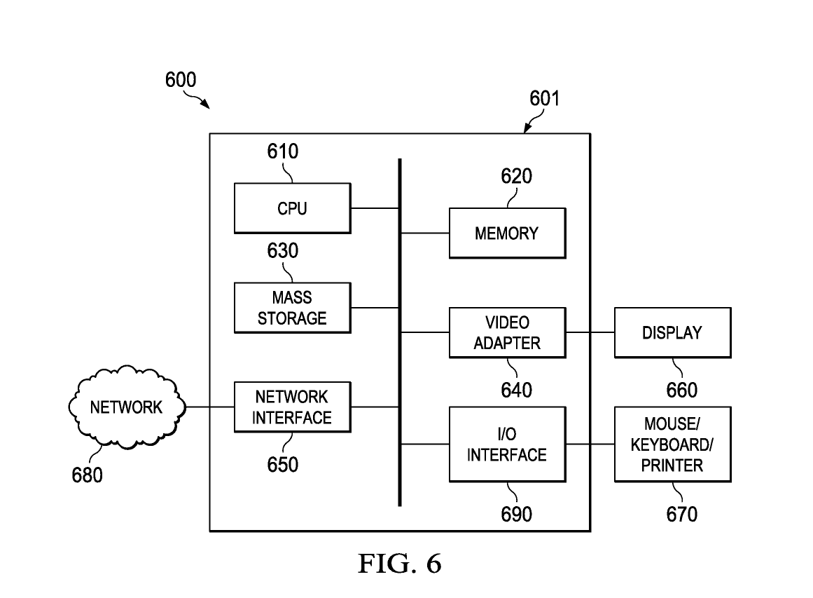

FIG. 6 is a block diagram of an exemplary processing system 600 that can be used to implement various embodiments. The processing system is part of any of the embodiment transmitter systems above, for instance to implement the DSP functions. The processing system 600 may comprise a processing unit 601 equipped with one or more input/output devices, such as a speaker, microphone, mouse, touchscreen, keypad, keyboard, printer, display, and the like. The processing unit 601 may include a central processing unit (CPU) 610, a memory 620, a mass storage device 630, a video adapter 640, and an Input/Output (I/O) interface 690 connected to a bus. The bus may be one or more of any type of several bus architectures including a memory bus or memory controller, a peripheral bus, a video bus, or the like.

The CPU 610 may comprise any type of electronic data processor. The memory 620 may comprise any type of system memory such as static random access memory (SRAM), dynamic random access memory (DRAM), synchronous DRAM (SDRAM), read-only memory (ROM), a combination thereof, or the like. In an embodiment, the memory 620 may include ROM for use at boot-up, and DRAM for program and data storage for use while executing programs. The mass storage device 630 may comprise any type of storage device configured to store data, programs, and other information and to make the data, programs, and other information accessible via the bus. The mass storage device 630 may comprise, for example, one or more of a solid state drive, hard disk drive, a magnetic disk drive, an optical disk drive, or the like.

The video adapter 640 and the I/O interface 690 provide interfaces to couple external input and output devices to the processing unit. As illustrated, examples of input and output devices include a display 660 coupled to the video adapter 640 and any combination of mouse/keyboard/printer 670 coupled to the I/O interface 690. Other devices may be coupled to the processing unit 601, and additional or fewer interface cards may be utilized. For example, a serial interface card (not shown) may be used to provide a serial interface for a printer.

The processing unit 601 also includes one or more network interfaces 650, which may comprise wired links, such as an Ethernet cable or the like, and/or wireless links to access nodes or one or more networks 680. The network interface 650 allows the processing unit 601 to communicate with remote units via the networks 680. For example, the network interface 650 may provide wireless communication via one or more transmitters/transmit antennas and one or more receivers/receive antennas. In an embodiment, the processing unit 601 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a transmitter for a direct detection system, the method comprising:
driving, via a drive voltage, a single-side band (SSB) signal at an optical modulator on a first optical path of the transmitter, wherein the SSB signal is sufficiently linear with respect to the drive voltage for allowing direct detection at a receiver;
generating a DC carrier signal on a second path of the transmitter; and
combining the SSB signal with the DC carrier signal at an output of the transmitter.

2. The method of claim 1, wherein the SSB signal is driven without a DC bias.

3. The method of claim 1 further comprising adjusting, according to an arc-sin function, the drive voltage, wherein the adjusted drive voltage increases linearity of the SSB signal with respect to the drive voltage.

4. The method of claim 1, wherein the SSB signal corresponds to a frequency-division multiplexing (OFDM) subcarrier.

5. The method of claim 1 further comprising generating the drive voltage using digital signal processing (DSP).

6. The method of claim 1 further comprising controlling a desired ratio of the SSB signal to the DC carrier signal by adjusting amplitudes of the SSB signal and the DC carrier signal.

7. The method of claim 6, wherein controlling the desired ratio of the SSB signal to the DC carrier signal comprises controlling optical taps at the first path and the second path to adjust the amplitudes of the SSB signal and the DC carrier signal.

8. A method by a transmitter for a direct detection system, the method comprising:
generating, using digital signal processing (DSP), a digital signal for optical communications;
generating, according to the digital signal, a drive voltage for an optical modulator;
splitting a laser output into a first path coupled to an optical modulator, and a second path separate from the optical modulator;
driving, using the drive voltage, a single-side band (SSB) signal at the optical modulator and the first path, wherein the SSB signal is sufficiently linear with respect to the drive voltage for allowing direct detection at a receiver;
generating a DC carrier signal at the second path; and
combining the SSB signal with the DC carrier signal into an output signal of the transmitter.

9. The method of claim 8, wherein the SSB signal is driven without a DC bias.

10. The method of claim 8 further comprising adjusting, according to an arc-sin function, the drive voltage, wherein the adjusted drive voltage increases linearity of the SSB signal with respect to the drive voltage.

11. The method of claim 8 further comprising limiting a bandwidth of the transmitter, wherein the limited bandwidth allows sufficient linearity of the SSB signal with respect to the drive voltage.

12. The method of claim 8, wherein generating the digital signal comprises performing power loading using a water filling algorithm.

13. A transmitter for a direct detection system, the transmitter comprising:
a laser source;
a first path and a second path both coupled to the laser source;
an optical modulator coupled to the first path;
at least one processor coupled to the optical modulator; and
a non-transitory computer readable storage medium storing programming for execution by the at least one processor, the programming including instructions to:
generate, using digital signal processing (DSP), a digital signal for optical communications;
generate, according to the digital signal, a drive voltage for the optical modulator;
drive, using the drive voltage, a single-side band (SSB) signal at the optical modulator;
generate a DC carrier signal on the second path; and
combine the SSB signal with the DC carrier signal into an output signal of the transmitter.

14. The transmitter of claim 13, wherein the instructions to drive the SSB signal includes instructions to drive the SSB signal at the optical modulator without applying DC bias to the optical modulator.

15. The transmitter of claim 13, wherein the programming includes further instructions to adjust, according to an arc-sin function, the drive voltage, wherein the adjusted drive voltage increases linearity of the SSB signal with respect to the drive voltage.

16. The transmitter of claim 13, wherein the programming includes further instructions to control a desired ratio of the SSB signal to the DC carrier signal by adjusting amplitudes of the SSB signal and the DC carrier signal.

17. The transmitter of claim 16, wherein the first path and the second path comprise optical taps, and wherein the instructions to control the ratio of the SSB signal to the DC carrier signal comprises instructions to control the optical taps to adjust the amplitudes of the SSB signal and the DC carrier signal.

18. The transmitter of claim 13, wherein the SSB signal corresponds to a frequency-division multiplexing (OFDM) subcarrier.

19. The transmitter of claim 13, wherein the optical modulator is a dual-parallel Mach-Zehnder (MZ) interferomater or a dual-drive MZ interferometer.

20. The transmitter of claim 13 , wherein the SSB signal is sufficiently linear with respect to the drive voltage for allowing direct detection at a receiver
